(19) United States
(12) Patent Application Publication
(10) Pub. No.: US 2013/0015276 A1
(43) Pub. Date: Jan. 17, 2013

(54) Milling of Granular Silicon

(71) Applicant: Raanan Y. Zehavi, San Jose, CA (US)

(72) Inventor: Raanan Y. Zehavi, San Jose, CA (US)

(73) Assignee: INTEGRATED PHOTOVOLTAIC, INC., San Jose, CA (US)

(21) Appl. No.: 13/268,041

(22) Filed: Oct. 7, 2011

Related U.S. Application Data
(63) Continuation-in-part of application No. 12/749,160, filed on Mar. 29, 2010.
(60) Provisional application No. 61/165,218, filed on Mar. 31, 2009.

(51) Int. Cl. B02C 17/00; B02C 1/08

(52) U.S. Cl. 241/24.1; 241/278.1

(57) ABSTRACT

Silicon particles, including powder suitable for plasma spraying semiconductor devices, is formed by milling by a roller mill including silicon rollers and/or plates and having feed and collection systems comprising silicon and operated in a controlled ambient.

### PRIORITY

This application is a continuation-in-part and claims priority from U.S. application Ser. No. 12/749,160, filed Mar. 29, 2010 and U.S. 61/165,218 filed Mar. 31, 2009.

### CROSS-REFERENCE TO RELATED APPLICATIONS

This application is related in part to U.S. application Ser. Nos. 12/074,651, 12/720,153, 12/749,160, 12/789,357, 12/860,048, 12/950,725, 12/860,088, 13/010,700, 13/019,965, 13/073,884, 13/104,881, 13/214,158, 13/234,316 and U.S. Pat. No. 7,789,331, all owned by the same assignee and incorporated by reference in their entirety herein. Additional technical explanation and background is cited in the referenced material.

### FIELD OF THE INVENTION

The invention relates generally to producing silicon powder useful for plasma spraying semiconducting devices such as solar cells. In particular, the invention relates to milling of silicon particles with a mill comprising silicon components.

### BACKGROUND ART

Integrated circuits based upon semiconducting silicon have conventionally been formed in monocrystalline silicon wafers cut from ingots grown by the Czochralski method, which includes pulling the ingot from a melt of pure silicon. Solar cells can also be made in such wafers, but the conventional monocrystalline silicon wafers are generally considered to be too expensive for solar cells to be effectively and widely deployed as an economical replacement for commercial power. As a result, much recent effort has been directed to developing economical techniques for depositing a semiconductor silicon layer on another substrate. Silicon particles, including powder suitable for plasma spraying semiconductor devices, is formed by milling by a roller mill including silicon rollers and/or plates and having feed and collection systems comprising silicon and operated in a controlled ambient.

One such technique involves plasma spraying thin layers of silicon onto foreign substrates, as described by Zehavi et al. in U.S. publication 2008/0220558. Zehavi discloses an improved design of the gun nozzle in U.S. patent application Ser. No. 12/720,153, filed 9 Mar. 2010. This technique includes injecting silicon powder into the flame of a plasma spray gun and directing the flame and entrained silicon toward the substrate. The silicon powder is melted and perhaps vaporizes in the flame but quickly solidifies when it strikes the substrate and forms a silicon layer it.

However, to form a photovoltaic solar cell or any type of significant semiconducting device, the device must include layers of silicon of different conductivity types. Further, the size of the powder used in plasma spraying must be controlled within a fairly narrow range of small dimension to facilitate processing. It have been found desirable to mill or otherwise reduce the size of silicon particles otherwise available on the market. However, the milling must maintain the purity of the silicon. Zehavi et al. have disclosed a jet mill for reducing the size of the silicon particles in U.S. Pat. No. 7,789,331. In order to maintain the purity of the milled silicon, the jet mill has walls composed of silicon so that the milling process does not incorporate non-silicon wall material into the milled silicon.

Further development work has suggested the typical commercially available silicon particles, formed like BB pellets, used as feedstock to the mill rapidly degrade the silicon parts of the milling chamber. Although the parts can be easily replaced with new silicon parts, silicon parts are generally expensive. If the final use of the milled powder is forming solar cells, it is important that all stages of the manufacturing process be economical to allow solar cells to compete with other more conventional forms of electrical power.

Prior art on roller mills and particle grinding is found in U.S. Pat. No. 5,312,056, U.S. Pat. No. 7,198,215, U.S. Pat. No. 7,832,671, U.S. 2004/0206835, U.S. 2011/0114768, U.S. 2011/0121772; all incorporated in their entirety by reference.

### SUMMARY OF THE INVENTION

According to one aspect of the invention, silicon particles are mechanically milled to a predetermined size; optionally, silicon particles may be jet milled to a powder of size suitable for plasma spraying of silicon, for example, of diameters in a range from about 5 microns to about 300 microns. The various aspects of the disclosed invention provide an economical and dependable process for producing silicon particles and powders of high purity and controlled size.

According to another aspect of the invention, silicon particles are crushed to a predetermined size by a roller mill including two rotating silicon rollers. A roller milling system may include a feed system which reciprocates along the lengths of the rollers in delivering silicon particles to the rollers. The feed system may include a linear funnel having a linear, generally rectangular outlet positioned away from the gap between the rollers. The funnel, a vibrating feeding trough for the funnel, and a collector pan positioned beneath the inter-roller gap are advantageously composed of silicon.

A roller milling system and its feed system are optionally disposed within an environmental chamber back filled with an inert gas such as nitrogen. When crushed particles are jet milled to a yet smaller size, the jet mill is placed in the same environmental chamber, optionally.

### BRIEF DESCRIPTION OF THE DRAWINGS

FIG. 1 is a schematic cross-sectional view of a spraying apparatus for silicon particles according to one aspect of the invention.

FIG. 2 is an orthographic view of one embodiment of a roller mill of another aspect of the invention.

FIG. 3 is an exploded orthographic view of the roller mill of FIG. 2.

FIG. 4 is a yet further exploded view of FIG. 3.

FIG. 5 is a cross-sectional view of the chamfered end of one of the rollers of FIG. 1.

FIG. 6 is a schematic cross-sectional view of a feeding system for the roller mill of FIG. 2.

FIG. 7 is a schematic representation of a environmental chamber in which the roller mill of FIG. 2 is disposed in an inert ambient.

FIGS. 8A, B and C show alternative embodiments of a roller milling apparatus.

FIG. 9 is a 3D cut-away schematic of one embodiment.

FIG. 10 is an isometric view of one embodiment.

### DETAILED DESCRIPTION OF THE EMBODIMENTS

Different aspects of the invention include mechanical grinding or crushing of silicon pieces to small particles of high purity and of controlled size. Mechanical grinding may be followed by an optional sieving and subsequent jet milling of the particles into yet smaller silicon powder. However, the silicon feedstock must be highly pure and the purity must be maintained during the grinding process.

The semiconductor industry has promoted the development of economical production of electronic grade silicon (EGS) of very high purity. In the usual Siemens process, gaseous precursors of hydrogen and trichlorosilane are injected into a reactor containing a hot seed rod of silicon. The precursors in a chemical vapor deposition (CVD) process deposit onto the seed rod as growing layers of polysilicon silicon to form a rod or ingot or boule of EGS, also called virgin polysilicon. The growth conditions favor the formation of high stress in the ingots. At the end of growth, the ingots are cooled and hit by a sharp instrument on the order of a hammer so that the ingot shatters into irregular chips or shards of silicon of size on the order of 2 mm to 20 mm typically having irregularly arranged sharp corners. Silicon chips are used to as feedstock to fill a crucible, which is then heated to melt the silicon from which monocrystalline silicon ingots are pulled in the Czochralski process. A related fluidized bed process uses approximately the same chemistry to produce a continuous output of generally spherical pellets or BBs of diameter on the order of 1 to 3 mm

Either chips or pellets may be milled to smaller, uniform sizes required for plasma spraying a layer of silicon powder to a substrate. The shards or pellets may be milled in at least two different procedures. In the first, relatively small silicon particles, such as BB pellets, are fed into a jet mill in which the particles are entrained in a vortex and strike each other or the walls of the milling chamber to progressively reduce the size of the particles as was described above for U.S. publication 2008/0054106. However, most commonly available silicon particle feedstock has larger size than desired and prematurely degrades the expensive silicon parts of the milling chamber.

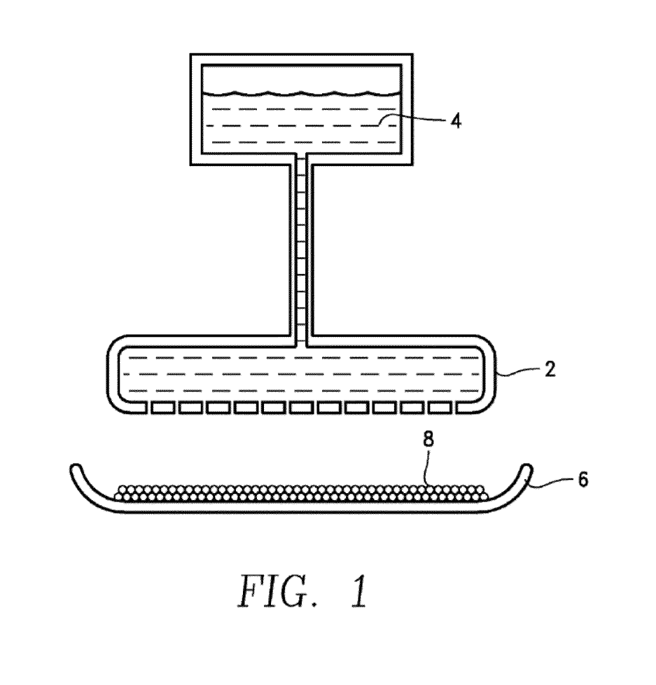

It is desirable to first reduce the size of silicon feedstock in a roller mill. The feedstock may be either the millimeter sized CVD pellets or the larger and more irregularly shaped shards from fractured boules of virgin polysilicon (electronic grade silicon). FIG. 1 shows an exemplary spraying apparatus.

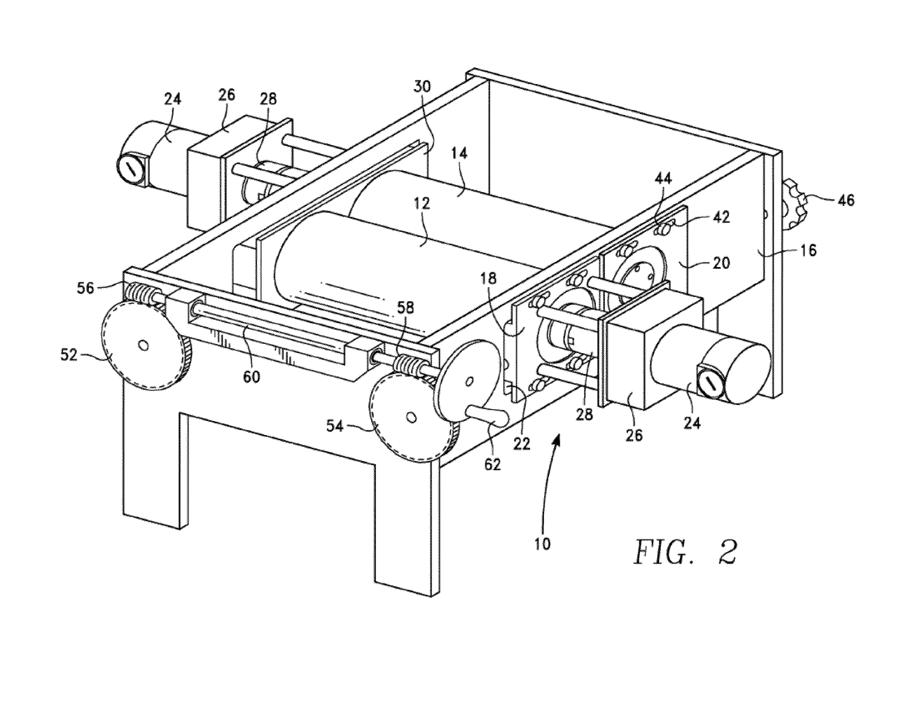

The roller milling process of one embodiment of the invention crushes the particles between two closely spaced rotating rollers having surfaces, optionally, entirely, composed of high-purity silicon. In one embodiment illustrated in the orthographic view of FIG. 2, a roller mill 10 includes two rollers 12, 14, each right cylindrically shaped about respective roller axes and composed of high-purity silicon, such as virgin polysilicon (electronic grade silicon) as described by Boyle et al. in U.S. Pat. No. 6,617,225; optionally other high purity silicon, such as float zoned silicon, may be used. Although silicon surfaces on a roller body of another material suffice, it has been found that solid elemental silicon can be easily machined into rollers which withstand the rigors of roller milling. High purity silicon has an impurity content less than 1 ppb. The right cylindrical surfaces may be smooth; optionally, one or both of the rollers 12, 14 may have patterned surfaces to facilitate grinding by more effectively gripping the particles. The rollers may be machined to very tight tolerances to allow a very small minimum gap between them of the order of 5 to 300 microns. To achieve such a gap and allow the rollers to rotate without binding, the circularity should be V000 inch (25 microns) or less, that is, outer diameters that differ no more than ±0.0005 inch from the average. The circularity is preferably less than the desired size of ground powder since the circularity limits how closely the rollers can be separated. Shafts are fixed on the rollers 12, 14 and portions extending from the opposed roller ends are mounted on a metal frame 16 through bearings supported in respective bearing housings or carriers 18, 20 (only two of the four being illustrated). Carriers 18, 20 are horizontally movable over short distances within windows 22 in the frame 16 to adjust the gap between the rollers 12, 14 and their parallelism but the carriers 18, 20 can be fixed at their desired horizontal positions. Rollers 12, 14 are mounted within a central opening of the frame 16 with a generally horizontal orientation with the axes of the rollers 12, 14 generally parallel in a same plane, which is either horizontal or a few degrees away from horizontal. Two motors 24 drive respective reducing gears 26, which are coupled through respective flexible shaft couplings 28 to the shafts of the respective rollers 12, 14 and rotate them at approximately the same rotation rate of about 2 to 5 rpm for rollers of diameter of about 4 to 6 inches (10 to 15 cm); optionally, rollers are rotated in the same direction or not. However, it has been found that slightly different rotation rates between the rollers 12, 14 operates better and more smoothly and avoids the pellets binding the rollers 12, 14. Clutches or torque limiters may be interposed between the motors 22, 24 and the rollers 12, 14. More simply, the current to the motors 24 may be controllably limited. In an improved design, motor torque may be specified and adjusted periodically.

Flexible shaft couplings 28 are intended to allow some angular misalignment or nutation between the shafts of the rollers 12, 14 and the associated motors 24 as silicon particles forced between rollers 12, 14 exert force on rollers 12, 14 and cause them to separate. Flexible shaft couplings 28 may be a two-stage bellows coupling with a rigid ring attached between them. The two sets of bellows provide rigid rotational torque but allow the rotational axes to bend. Thereby, the motor and roller shafts maybe slightly inclined or radially displaced from each other. Such flexible shaft couples are available from Nuland Manufacturing Co. of Marlborough Mass.

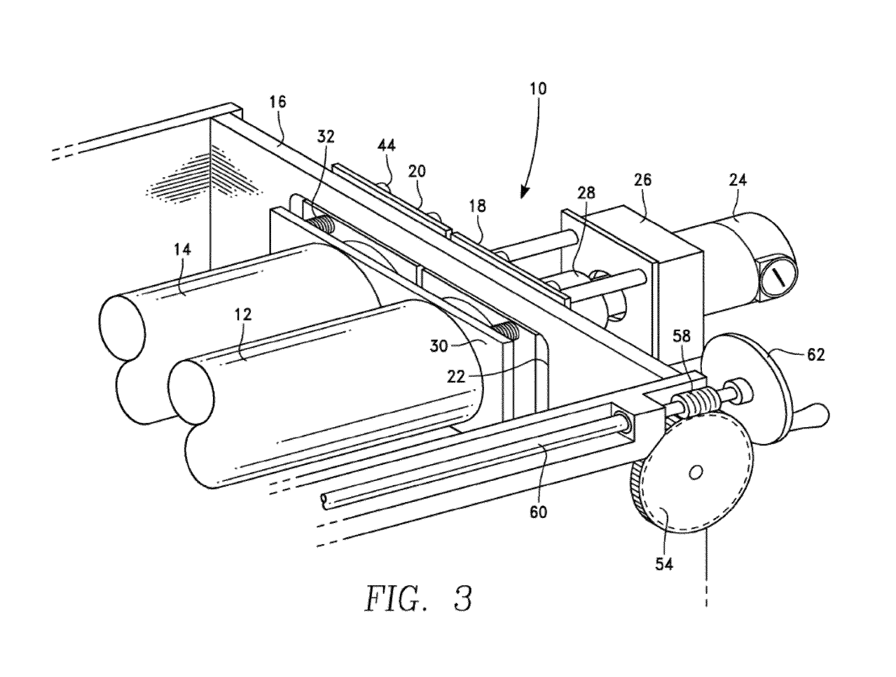

As illustrated in more detail in the enlarged orthographic view of FIG. 3, end plates or shields 30 are mounted to the inside of the frame 16 through compression springs 32 connected between the carriers 18, 20 and the shields 30 which bias the shields 30 against the axial ends of the two rollers 12, 14. However, the shields 30, which may be generally flat, include apertures for the shafts of the rollers 12, 14. The springs 32 cause the shields 30 to abut the ends of rollers 12, 14, to prevent unground and partially ground particles from falling off the ends of rollers 12, 14 and thereby shield the bearings from the grinding dust. The shields 30 may be composed of high-purity silicon, such as virgin polysilicon, such that any grinding between the rollers 12, 14 and the shields 30 produces only high-purity silicon particles and thus protects rollers 12, 14 from metallic contamination. However, secondary grinding should be minimized; optionally there may be a more complexly shaped interface between rollers 12, 14 and shields 30.

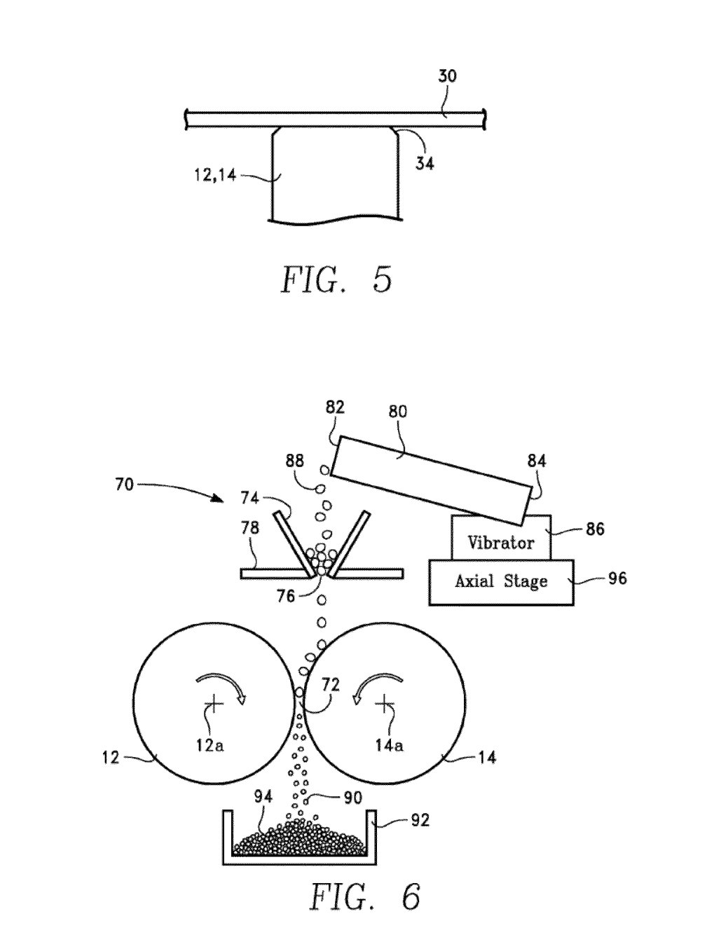

It is advantageous to form chamfers 34 in the corners of rollers 12, 14 adjacent shields 30, as illustrated in the cross-sectional view of FIG. 5. Chamfers 34 reduce breakage of rollers 12, 14 contacting the shields 30 as they rotate about roller axes 12a, 14a. Silicon is sensitive to shock and to cracking and fracturing; optionally, a plastic such as Teflon may be interposed between silicon and metal parts.

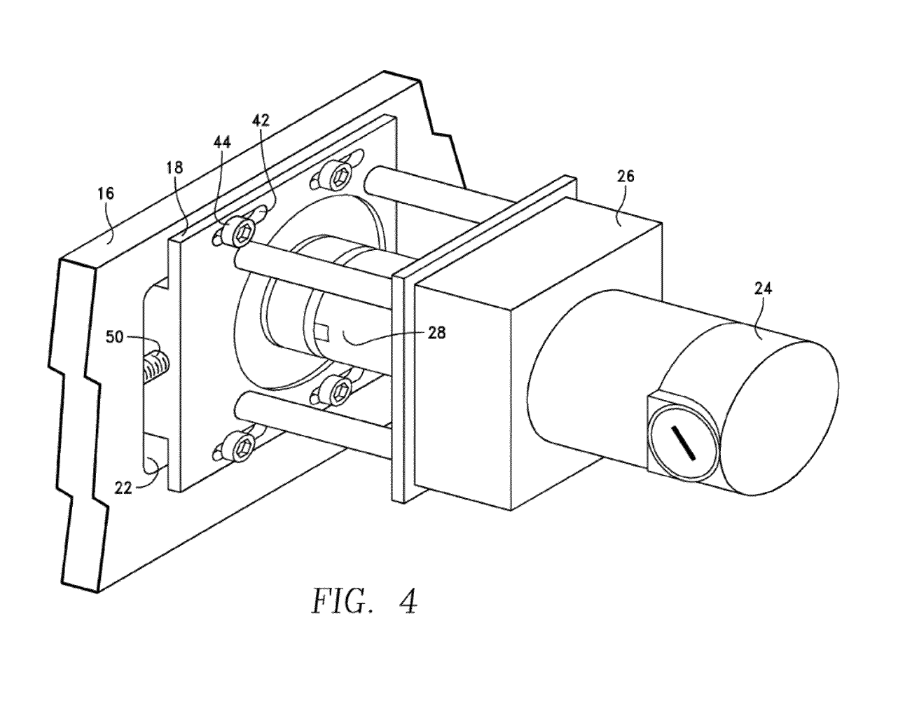

Each of the four carriers 18, 20 supporting rollers 12, 14 and their motors 24 is horizontally guided along four horizontal slots 42, illustrated in detail in the orthographic view of FIG. 4, in the carriers 18, 20 closely passing the thread bodies of socket head cap screws 44 screwed into the frame 16. In view of the large lateral forces produced by crushing, the holding power of cap screws 44 can be increased by roughening one or both engaging surfaces at the interface between the carriers 18, 20 and the frame 16. Other guiding means such as square keys engaged in horizontally extending keyways. The carriers 18, 20 are horizontally movable through adjustment mechanisms. The adjustment mechanisms for the carriers 20 associated with the second roller 14 may be two simple knobs 46 and attached threaded rod screwed into the respective carrier 20 and axially retained in the frame 16.

Once the desired orientation of the first roller 14 has been accomplished, cap screws 44 on the carriers 20 are tightened to fix the first roller 14 in that orientation. The adjustment mechanism for the carriers 18 associated with the first roller 12 may be more complex. Threaded rods 50, illustrated more clearly in the yet further enlarged orthographic view of FIG. 4, are threaded into the respective carriers 18. Their other ends are axially retained in the frame 16 and connected to wheel gears 52, 54, each engaged through respective worm gears 56, 58 on a rotary shaft 60 having an adjustment handle 62 on its end to simultaneously and equally move both carriers 18 associated with the first roller 12 in the horizontal direction toward or away from the first roller 14 to thereby provide a tandem adjustment mechanism.

In one optional mode of operation, the wheel gears 52, 54 are coupled together and the carriers 18 associated with the first roller 12 are locked in place by their cap screws 44. The two carriers 20 associated with the second roller 14 are unlocked by loosening their cap screws 44, and the two handles 46 adjust the position of the unlocked carriers 20 until the two rollers 12, 14 closely engage along their entire lengths. As a result, the axes of the first and second rollers 12, 14 are parallel and the gap between them is essentially zero. The cap screws 44 on the carriers 20 associated with the second roller 14 are then tightened to lock the second roller 14 into its final position. Thereafter, any rotation of the adjustment handle 62, assuming the cap screws 48 on the carriers 18 of the first roller 12 are loosened, causes the gap between the two rollers 12, 14 to change but to be uniform along the lengths of the rollers 12, 14. In practice, it has been found sufficient to use a feeler gauge between the rollers 12, 14 to establish a gap, for example, at 100 microns, and to thereafter lock the carriers 18, 20 and associated rollers 12, 14 in place with or without the use of a tandem adjustment mechanism. It is understood that cap screws and adjustment handle can be replaced by electro-mechanical means to make desired adjustments and to fix them in place. The locking of the carriers 18, 20 can be further improved by placing lock nuts on the two threaded rods 50 associated with the carriers 18 of the first roller 12 and on two, not shown, rods associated with carriers 20 of the second roller 14. All the threaded rods are axially retained in the frame 16 but threaded into the respective carriers 18, 20 to form respective worm drives. Once a desired inter-roller gap is established, the lock nuts are tightened against the associated carriers 18, 20. In some embodiments a gap between the rollers may be set between about 0 to about 2 microns; optionally between about 0 and about 10 microns; optionally between about 10 and about 50 microns; optionally between about 50 and about 100 microns; optionally between about 100 and about 300 microns; optionally between about 0 and about 300 microns.

Once a gap is selected and fixed, preferably by tightening the cap screws 44 and lock nuts, silicon particles are loaded into the V-shaped region between the tops of the rollers 12, 14; rotating rollers 12, 14 crush the particles into predetermined sized particles, which fall through the gap between the rollers 12, 14 and are collected in a pan, not shown, positioned beneath the gap between rollers 12, 14. For purposes of this invention, grinding and milling are equivalent terms unless specified otherwise; crushing with a roller mill is a special case of milling.

The size of the inter-roller gap may be varied; acceptable sized powder is produced for differently sized BBs for a variety of gap sizes. Gaps as small as five microns have been successfully tested. Powder loading needs to be carefully controlled. If too few particles are loaded, the conversion rate or yield decreases. If too many particles are loaded, rollers may jam. It is thus desirable to constantly feed particles to the rollers, for example, by a conveyor or elevator. However, particles should be evenly distributed along the length of the rollers.

An embodiment of a feedstock supply system 70, illustrated in the cross-sectional view of FIG. 5, is generally positioned above the two rollers 12, 14 separated by a gap 72 and rotating about their respective centers to force silicon feedstock fed from above downwardly through gap 72, thereby milling and crushing feedstock to acceptable sized particles. Linear funnel 74 is formed of two inclined sidewalls extending into the plane of the illustration parallel to the axes 12a, 14a of rollers 12, 14, with closed ends. Linear funnel 74 includes at its bottom outlet slot 66 extending linearly parallel to the axes of rollers 12, 14. Shield 78 extends on the sides away from outlet 76 to confine powder to the area above inter-roller gap 72. Funnel outlet slot 76 may be positioned vertically above one of rollers 12, 14 away from inter-roller gap 72 so that any particles broken in the crushing or even unground BB pellets do not fly upwardly through the funnel outlet slot 66. Funnel 74 and shield 78 are advantageously formed of high-purity silicon such as virgin poly-silicon. Thereby, upwardly flying particles striking the funnel 78 or shield 78 do not ablate contaminants from them. An inclined V-shaped trough 80 is positioned with its open end vertically above the funnel 74 and its closed end 84 supported on a vibrator 86. A not shown feeder means continuously or intermittently supplies silicon particles to closed end 84 of trough 80, which is inclined upwardly toward the open end 82. This portion of the feedstock supply system 70 has been described in U.S. publication 2008/0054116. As described therein, vibration may cause small particles to march up the bottom of the inclined trough 80 and fall from its open end 82 as fed particles 88, which pass through funnel outlet 76 to be crushed to an undesirable size the rotating rollers 12, 14. Crushed particles 90 fall into a collector pan 92 and develop into a mound 94 of ground silicon powder. Preferably trough 80 and collector 90 are also made of high-purity silicon; optionally other materials such as polypropylene or Teflon may be used for collector pan 80.

Vibrator 86 is mounted on an axial stage 94 which reciprocates in the axial direction of the two rollers 12, 14 such that silicon feedstock is distributed along the lengths of rollers 12, 14.

Silicon oxidizes quickly in air, especially during the grinding phase when dangling silicon bonds are exposed at the fracture plane; optionally, crushing may be done in an inert ambient, for example, nitrogen or argon. In some embodiments oxygen partial pressure is kept to less than 100 ppm (10⁻⁴) of nominal oxygen content in air. Further, milling produces fine powder which presents an inhalation problem and silicon powder may ignite and burn, that is, oxidize, in the presence of oxygen. Both problems are greatly reduced by crushing within an enclosure filled with inert gas.

Nitrogen reacts with the silicon dangling bonds created during crushing; the resultant very thin nitride layer may act as a protective layer against subsequent oxidation of the underlying silicon, which, absent the protective layer, may develop more deeply into the ground silicon particle.

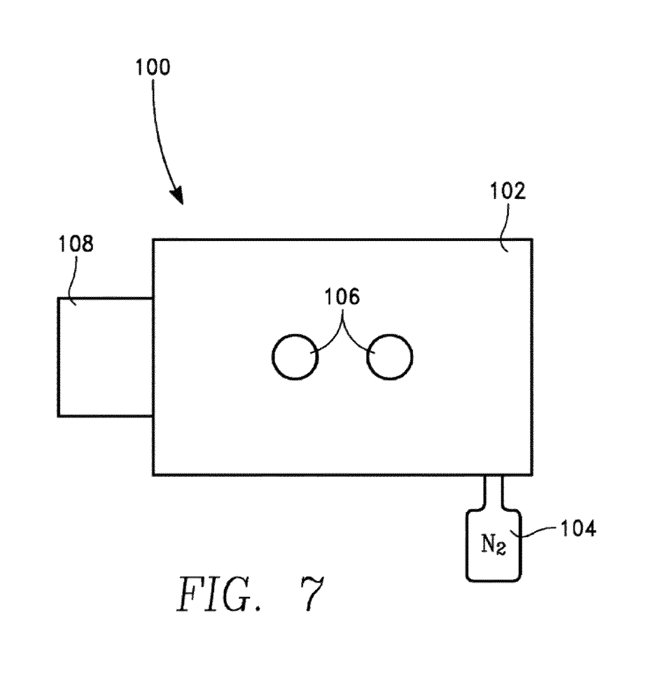

An example of an environmental processing chamber 100, schematically illustrated in FIG. 7 includes a vacuum-pumped or vented glove box 102. A nitrogen source 104 supplies nitrogen to the glove box 102 to achieve the desired low concentration of oxygen. The glove box 102 includes two glove holes 104 with gloves sealing the interior from the exterior but allowing an operator to manually manipulate equipment and products within the nitrogen-filled glove box 102.

Crushing system 10 and feed system 70 are located inside the glove box 102. The glove box 102 also includes a load lock 108 having an exterior vacuum door to ambient, an interior vacuum door to the interior of the glove box 102 and an interior of sufficient size for accommodating feedstock and ground product. In operation, feedstock is placed from the exterior into load lock 108 and its exterior door is closed. After load lock 108 has been backfilled with nitrogen to the requisite low oxygen level, the interior door is opened and the operator working through the glove holes 106 can transfer feedstock to the feed system. At the end of grinding a load of feedstock, an operator may transfer the contents of the collector pan into a sealable bottle, which is then transferred out of the glove box 102 through the load lock 108 and a new load of feedstock may be loaded into the glove box 102.

The disclosed milling apparatus is effective at producing significant amounts of milled silicon particles since the crushing is substantially a continuous process. However, it is understood that industrial production would be in large part automated and material would preferably be continuously loaded and unloaded.

Crushed silicon may be sieved to obtain the appropriate size for jet milling to minimize damage to its silicon walls, for example, in the range of about 5 to 300 microns. Sieving also removes elongate particles having minor dimensions less than the inter-roller gap 72 but a major dimension larger than the inter-roller gap 72. Sieving is performed with sieves of different screen mesh sizes having uniform hole sizes in the range of 5 to 300 microns. The size of the mesh screen determines the maximum size of the particles passing the screen. A lower limit of the particle size can be achieved by a separate sieving step with a smaller mesh size and retaining the particles not passed through the sieve. Of course, sieving selects particles according to their minimum dimensions and irregularly shaped particles having larger maximum dimensions than the screen mesh may nonetheless pass the mesh. A screen material may be non-metallic, for example, nylon or a castable ceramic. Sieving has demonstrated that the roller mill may produce particles considerably different than the inter-roller gap 72.

One mode of grinding produces both fine powder and larger particles, which may been partially crushed but not reduced to powder. After sieving, larger particles may be milled multiple times to increase the yield of fine powder. Progressive grinding can be accomplished in at least two ways. In a first approach, relatively large particles are ground with a relatively large inter-roller gap. The ground particles are collected, the inter-roller gap is reduced, and the particles are ground a second time. This process can be repeated more times. In a second approach, multiple roller mills 10 are stacked above each other with their respective rollers 12, 14 approximately above each other and more importantly their inter-roller gaps are approximately above each other so that the powder ground in the uppermost roller mill is immediately ground again in the next lower roller mill. The inter-roller gaps are selected to be largest for the highest mill and to progressively decrease for the lower mills. It is even possible to use the same inter-roller gap among the stacked crushers to increase the yield.

The silicon powder produced by the roller mill may be used as feedstock for a silicon-lined jet mill or it may be used directly as the feedstock for a plasma gun comprising silicon components. When crushed silicon powder is to be further ground in a jet mill, the jet mill may additionally be placed within the glove box 102 and the crushed particles transferred to the jet mill without being removed from the glove box 102.

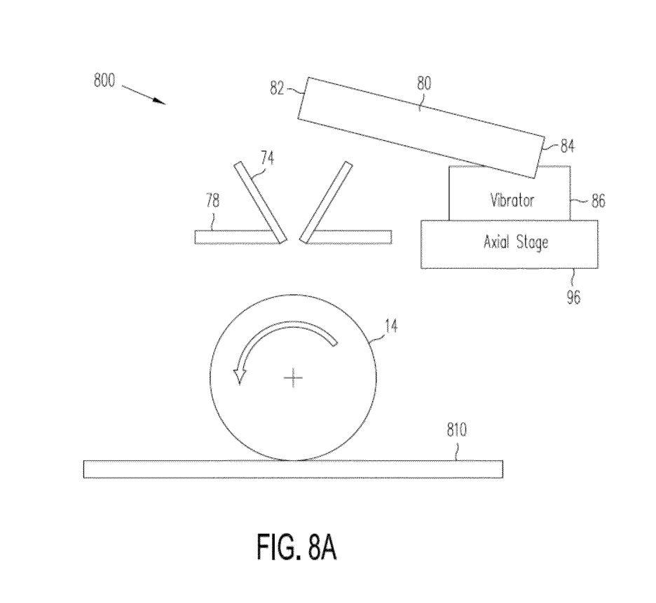

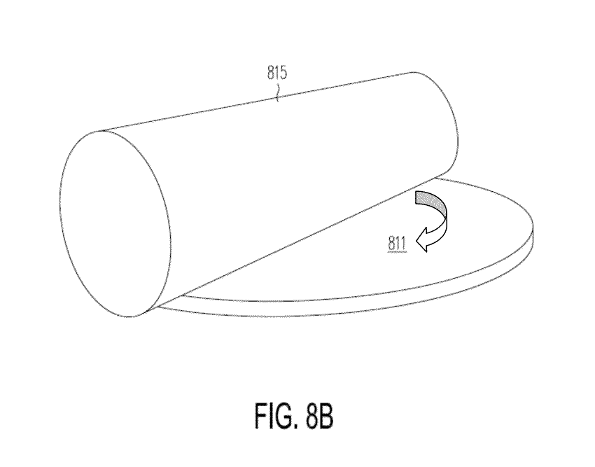

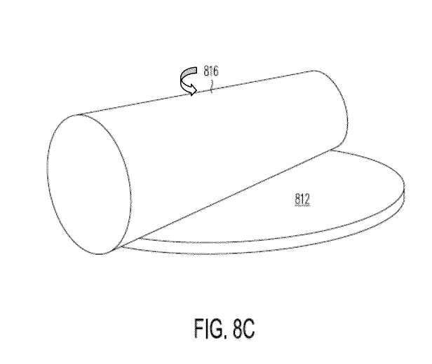

In some embodiments one roller, optionally 12 or 14, may be a flat plate, optionally, rotating, such that the roller, 12 or 14, is maintained at a preferred separation distance from the plate based upon the desired particle size and distribution. FIGS. 8A, B and C show alternative embodiments wherein in FIG.8A a roller 14 is rotating about its cylindrical axis against fixed plate 810; optionally, clockwise or counter-clockwise. In FIG. 8B, plate 811 is rotating under roller 815, optionally, fixed or rotating. In FIG. 8C, roller 816 is revolving about fixed plate 812; note, roller 816 is not rotating about its cylindrical axis but revolving around an axis perpendicular to its cylindrical axis; plate 812 is, optionally, fixed or rotating. Optionally, rotating and revolving may be done in a clockwise or counter-clockwise direction; in some embodiments with a single roller and a plate both may rotate. In some embodiments the separation between roller and plate is not fixed but set naturally by the milling process and size of particles fed in; in some embodiments the separation between roller and plate is a predetermined number which may serve as a minimum set point when particles larger than the minimum are introduced. In all cases the external compositions of a roller and a plate are nominally the same as the particles being milled or of a higher purity than the particles; optionally, an entire roller and entire plate are of similar composition and a composition consisting of about the same or fewer impurities when compared to the material being milled.

In some embodiments, not shown, roller 816 is replaced with a plate such that the milling is done by two plates; plate 812 is, optionally, fixed or rotating. In these embodiments a preferred mode is that at least one plate is rotating, optionally, concentrically, or not concentrically; optionally, when the two plates are rotating it is with opposing directions.

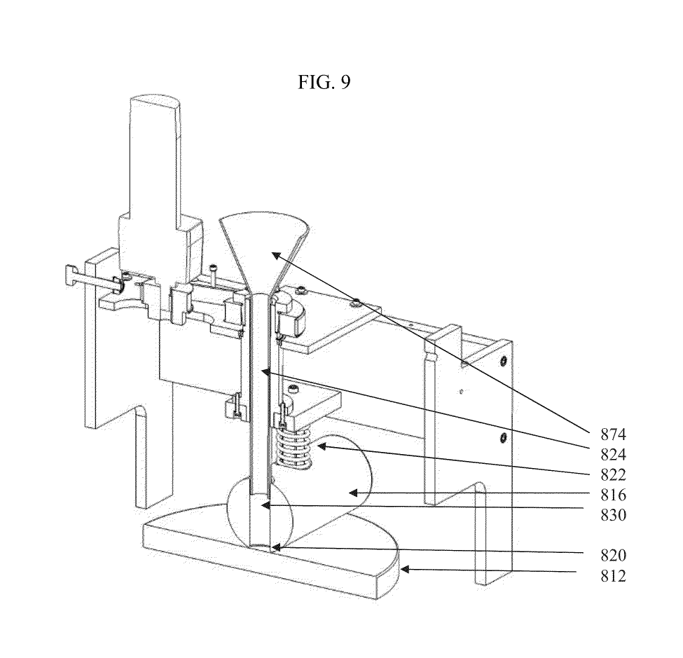

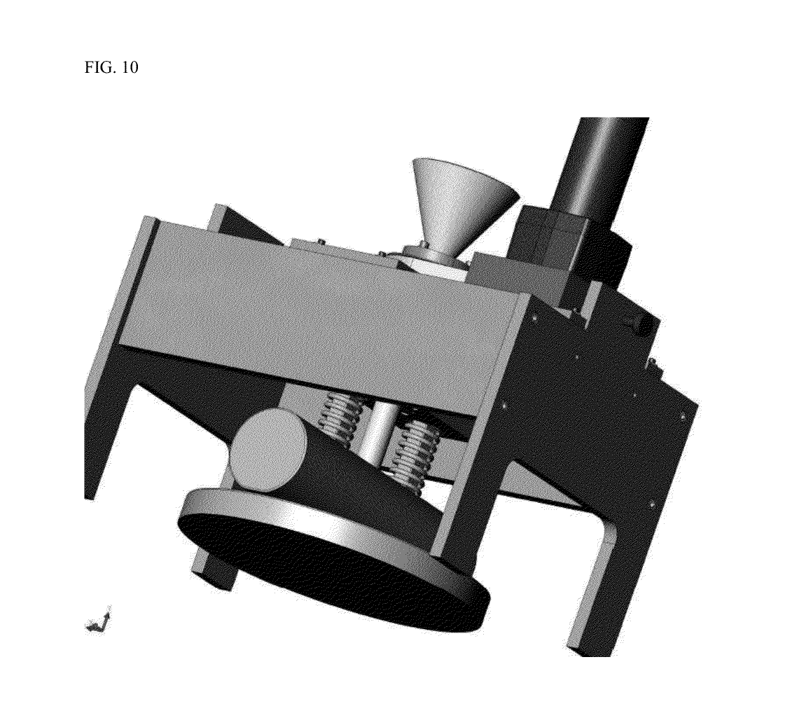

FIG. 9 is drawn symmetrical about channel 830; FIG. 10 shows a full on 3D schematic embodiment wherein roller 816 revolves around plate 812; additionally funnel 874 feeds particles or feedstock through channel 824 into roller channel 830 to plate 812. In this embodiment roller 816 has a flat region 820 machined along its contact area with plate 812 to increase the interface area; roller channel 830 is aligned within this flat region 820. Optionally, a spring 822 is employed to increase the pressure between roller 816 and plate 812. FIG. 10 shows an isometric view of FIG. 9 with two springs 822 in place on roller 816. In one embodiment roller 816 is 6 in. in diameter by 18 in. long, weighing about 43 lbs; a 2 in. flat along the length of the roller is about 36 sq.in. resulting in a downward pressure of about 1 psi. Optional springs 822 are used to increase the pressure between the roller and plate from about 1 psi to, optionally, 5 to 50 psi, depending upon the feedstock size, final particle size desired and material composition being milled.

In some embodiments a means for milling comprises a first means for milling and a second means for milling chosen from a group consisting of cylindrical roller and flat plate; some embodiments comprise two rollers, some two plates and some a plate and a roller; in some embodiments the roller(s) rotates about its cylindrical axis; in some embodiments the roller revolves around an axis perpendicular to its cylindrical axis; in some embodiments the plate(s) rotates about the axis perpendicular to a face; in some embodiments the first or second means for milling rotates; in some embodiments both the first and second means for milling rotate, optionally not concentrically; in some embodiments the first or second means for milling revolve while the other means may rotate. In all cases, a means for milling is of the same composition as the feedstock being milled or comprises a higher concentration of the major constituent, or major constituents when an alloy is a feedstock.

In some embodiments a roller mill adapted for milling silicon pieces into powder comprises a pair of juxtaposed rotatable rollers consisting substantially of silicon wherein a predetermined gap is set between the rollers and the silicon content of the rollers is equal to or greater than the silicon content of the silicon pieces; optionally, the gap is set less than about 300 microns; optionally, the end plates have at least a surface portion consisting substantially of silicon biased against axial ends of the rollers; optionally, the corners of the rotatable rollers adjacent the end plates are chamfered.

In some embodiments a roller mill system adapted for milling pieces of a first composition into powder comprises a plurality of vertically stacked pairs of juxtaposed rotatable rollers wherein a predetermined gap is set between the rollers and the composition of the rollers is substantially the same as the first composition; optionally, the roller mill system further comprises a feed system reciprocating parallel to the axes of the rollers for feeding feedstock to the rollers; optionally, the feed system includes a linear outlet; optionally, the linear funnel comprises a channel for transporting the feedstock consisting substantially of the first material composition.

In some embodiments a method of making powder from a feedstock of a first composition, comprises the steps: setting a predetermined gap in a range less than about 300 microns between a first and second means for milling composed substantially of the first composition and comprising end plates having at least a surface portion consisting substantially of the first composition biased against axial ends of the first and second means for milling wherein corners of the first and second means for milling adjacent the end plates are chamfered; milling the feedstock to form a powder; and sieving the powder of the milling step to a predetermined size range; optionally, the sieved powder size range is between about 5 microns and about 300 microns.

In some embodiments a roller mill system operable to mill high purity silicon feedstock into silicon powder comprises a pair of vertically stacked, juxtaposed rotatable rollers consisting substantially of high purity silicon wherein a predetermined gap less than about 300 microns is set between the rollers; end plates having at least a surface portion consisting substantially of high purity silicon biased against axial ends of the rollers and wherein corners of the rotatable rollers adjacent the end plates are chamfered; and a feed system reciprocating parallel to the axes of the rollers for feeding high purity silicon feedstock to the rollers comprising a linear outlet such that the linear outlet is positioned above one of the rollers and wherein the high purity silicon of the rollers is of silicon content equal to or greater than the high purity silicon of the silicon feedstock.

In some embodiments a roller mill system operable to mill high purity silicon feedstock into powder comprises a flat plate and a roller wherein at least one of the flat plate or the roller rotate or revolve; and a feed system for feeding silicon feedstock to the roller or plate comprising a linear outlet such that the linear outlet is connected to the roller wherein the compositions of the flat plate and the roller are of silicon content equal to or greater than the silicon content of the silicon feedstock; optionally, the roller comprises a channel for conducting the silicon feedstock to the plate.

In some embodiments a method of making silicon powder from silicon feedstock, comprises the steps; setting a predetermined pressure between a roller and a flat plate both composed substantially of silicon wherein the silicon content of the roller and the plate is equal to or greater than the silicon content of the silicon feedstock; rotating or revolving at least one of the roller or the flat plate; feeding silicon feedstock to the plate along a channel; optionally, the channel passes through the roller, with a surface of high purity silicon upon which the silicon feedstock traverses; and milling silicon pieces to form silicon powder; optionally, setting a predetermined pressure between a roller and a flat plate may be done by adjusting the weight or size of a top roller or plate such that just the weight of the roller or plate applies sufficient pressure for milling.

In some embodiments a roller mill system operable to mill feedstock of a first composition into powder comprises a first means for milling and a second means for milling wherein one of the first or second means for milling rotate or revolve; and a feed system for feeding feedstock to the first means for milling wherein the compositions of the first and second means for milling are substantially of the first composition and wherein the first means for milling comprises a channel for conducting the feedstock to the plate.

In the previous description, numerous specific details are set forth to provide a thorough understanding of the present invention. However, it will be apparent to one of ordinary skill in the art that the invention may be practiced without these particular details. In other instances, methods, procedures, and components that are well known to those of ordinary skill in the art are not described in detail to avoid obscuring aspects of the present invention.

It will be understood that when a layer is referred to as being “on top of” another layer, it can be directly on the other layer or intervening layers may also be present. In contrast, when a layer is referred to as “contacting” another layer, there are no intervening layers present. Similarly, it will be understood that when a layer is referred to as being “below” another layer, it can be directly under the other layer or intervening layers may also be present.

It will also be understood that, although the terms first, second, etc. may be used herein to describe various elements, these elements should not be limited by these terms. These terms are only used to distinguish one element from another. For example, a first layer could be termed a second layer, and, similarly, a second layer could be termed a first layer, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entirety.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A roller mill adapted for milling silicon pieces into powder comprising:
a pair of juxtaposed rotatable rollers consisting substantially of silicon wherein a predetermined gap is set between the rollers and the silicon content of the rollers is equal to or greater than the silicon content of the silicon pieces.

2. The roller mill of claim 1, wherein the gap is set less than about 300 microns.

3. The roller mill of claim 1, further comprising end plates having at least a surface portion consisting substantially of silicon biased against axial ends of the rollers.

4. The roller mill of claim 3, wherein corners of the rotatable rollers adjacent the end plates are chamfered.

5. A roller mill system adapted for milling pieces of a first composition into powder comprising;
a plurality of vertically stacked pairs of juxtaposed rotatable rollers wherein a predetermined gap is set between the rollers and the composition of the rollers is substantially the same as the first composition.

6. The roller mill system of claim 5 further comprising a feed system reciprocating parallel to the axes of the rollers for feeding feedstock to the rollers.

7. The roller mill system of claim 6, wherein the feed system includes a linear outlet.

8. The roller mill system of claim 7, wherein the linear funnel comprises a channel for transporting the feedstock consisting substantially of the first material composition.

9. A method of making powder from a feedstock of a first composition, comprising the steps:
setting a predetermined gap in a range less than about 300 microns between a first and second means for milling composed substantially of the first composition and comprising end plates having at least a surface portion consisting substantially of the first composition biased against axial ends of the first and second means for milling wherein corners of the first and second means for milling adjacent the end plates are chamfered;
milling the feedstock to form a powder; and
sieving the powder of the milling step to a predetermined size range.

10. The method of claim 9, wherein the sieved powder size range is between about 5 microns and about 300 microns.

11. A roller mill system operable to mill high purity silicon feedstock into silicon powder comprising:
a pair of vertically stacked, juxtaposed rotatable rollers consisting substantially of high purity silicon wherein a predetermined gap less than about 300 microns is set between the rollers;
end plates having at least a surface portion consisting substantially of high purity silicon biased against axial ends of the rollers and wherein corners of the rotatable rollers adjacent the end plates are chamfered; and
a feed system reciprocating parallel to the axes of the rollers for feeding high purity silicon feedstock to the rollers comprising a linear outlet such that the linear outlet is positioned above one of the rollers and wherein the high purity silicon of the rollers is of silicon content equal to or greater than the high purity silicon of the silicon feedstock.

12. A roller mill system operable to mill high purity silicon feedstock into powder comprising:
a flat plate and a roller wherein at least one of the flat plate or the roller rotate or revolve; and
a feed system for feeding silicon feedstock to the roller or plate comprising a linear outlet such that the linear outlet is connected to the roller wherein the compositions of the flat plate and the roller are of silicon content equal to or greater than the silicon content of the silicon feedstock.

13. A roller mill system of claim 13 wherein the roller comprises a channel for conducting the silicon feedstock to the plate.

14. A method of making silicon powder from silicon feedstock, comprising the steps:
setting a predetermined pressure between a roller and a flat plate both composed substantially of silicon wherein the silicon content of the roller and the plate is equal to or greater than the silicon content of the silicon feedstock;
rotating or revolving at least one of the roller or the flat plate;
feeding silicon feedstock to the plate along a channel [through the roller] with a surface of high purity silicon upon which the silicon feedstock traverses; and
milling silicon pieces to form silicon powder.

15. A roller mill system operable to mill feedstock of a first composition into powder comprising:
a first means for milling and a second means for milling wherein one of the first or second means for milling rotate or revolve; and
a feed system for feeding feedstock to the first means for milling wherein the compositions of the first and second means for milling are substantially of the first composition and wherein the first means for milling comprises a channel for conducting the feedstock to the plate.
